(19) United States
(12) Patent Application Publication
(10) Pub. No.: US 2025/0156953 A1
(43) Pub. Date: May 15, 2025

(54) SYSTEMS AND METHODS FOR USING CROSS-CHAIN PORTFOLIO MANAGEMENT PLATFORMS

(71) Applicant: JPMORGAN CHASE BANK, N.A., New York, NY (US)

(72) Inventors: Tyrone D LOBBAN, Loughton (GB); Dennis CRISTALLO, New York, NY (US); Keerthi MOUDGAL, Brooklyn, NY (US); Kirsten JONES, Southbourne (GB); Stephanie LOK, New York, NY (US); Aditya Mayur TADAY, Hoboken, NJ (US); Manmeet AHLUWALIA, Tampa, FL (US); Ganesh ANANTWAR, Mumbai (IN); Chang Yang JIAO, New York, NY (US); Abhishek AGARWAL, Bengaluru (IN)

(21) Appl. No.: 18/948,001

(22) Filed: Nov. 14, 2024

Related U.S. Application Data
(60) Provisional application No. 63/598,811, filed on Nov. 14, 2023.

(51) Int. Cl. G06Q 40/06; G06Q 20/10; G06Q 40/04

(52) U.S. Cl. CPC G06Q 40/06; G06Q 20/108; G06Q 40/04

(57) ABSTRACT

A method may include: a model registry smart contract on a primary permissioned blockchain-based network receiving template portfolio models; the model registry smart contract deploying an investor portfolio smart contract for an investor portfolio to the primary network; a rebalancer module calculating a subscription order to align the investor portfolio to the selected template portfolio model; the investor portfolio smart contract sending the subscription order to an orchestrator smart contract; the orchestrator smart contract routing the subscription order to a secondary permissioned blockchain-based network via an interoperability service that translates the subscription order for the secondary network, receives a settlement confirmation from the secondary network, and translates the settlement confirmation for the primary network; the orchestrator smart contract recording asset positions based on the settlement confirmation; and the investor portfolio smart contract transferring deposit tokens to a fund manager address for the fund on the primary network.

### RELATED APPLICATIONS

This application claims priority to, and the benefit of, U.S. Provisional Patent Application Ser. No. 63/598,811, filed Nov. 14, 2023, the disclosure of which is hereby incorporated, by reference, in its entirety.

### BACKGROUND OF THE INVENTION

Embodiments are generally directed to systems and methods for using cross-chain portfolio management platforms.

Within the wealth management industry, building and managing discretionary portfolios for wealthy individuals is a $5.5 trillion business that enables millions of investors to meet their financial goals. The top firms in this space have built robust and sustainable businesses that have delivered results for their investors. However, wealth management firms' ability to create innovative solutions and realize further efficiencies on existing technology infrastructure is limited.

Blockchain technology, tokenization and smart contracts (i.e., self-executing programs that automate the actions required in blockchain transactions) open a broader design space on which firms can build the next generation of managed solutions, including alternative investment funds that historically have been more difficult to access.

Access to and distribution of tokenized assets, however, is fragmented across blockchain networks. In recent years, tokenization of assets has gained traction and adoption across industries. The inherent capabilities of blockchain networks to unify bookkeeping and computation make it possible to leverage tokenization of traditional assets and the benefits that come therefrom. While traditional assets have been represented on blockchain networks through standardized token representations and logic, these ecosystems have developed in a fragmented manner—creating tradeoffs where benefits are gained at the expense of aggregated liquidity. Consequently, dozens of permissionless public and permissioned private networks have resulted in isolated ecosystems, with disjointed users, applications, and liquidity pools. These networks employ different security models, consensus mechanisms, and development environments, preventing value and data flow between networks. This fragmentation has spurred the emergence of interoperability protocols that act as bridges that connect disparate digital islands. Just as tokenization standardized asset representation on-chain, interoperability solutions aim to standardize how these siloed ecosystems communicate to enable seamless cross-chain transactions while still allowing decentralized development to continue within each chain.

### SUMMARY OF THE INVENTION

Systems and methods for using cross-chain portfolio management platforms are disclosed. According to an embodiment, a method may include: receiving, on a primary permissioned blockchain-based network and by a model registry smart contract, a plurality of template portfolio models for a plurality of investors; receiving, by the primary permissioned blockchain-based network, a deployment of an investor portfolio smart contract for an investor portfolio for an investor; in response to the deployment, linking, by the model registry smart contract, the investor portfolio smart contract to a selected template portfolio model; establishing, by a deposit token smart contract, a tokenized cash balance for the investor; receiving, by the investor portfolio smart contract, the tokenized cash balance; calculating, by a rebalancer module, a subscription order to align the investor portfolio to the selected template portfolio model, wherein the subscription order identifies a fund and an investment amount; sending, by the investor portfolio smart contract, the subscription order to an orchestrator smart contract; routing, by the orchestrator smart contract, the subscription order to a secondary permissioned blockchain-based network via an interoperability service, wherein the secondary permissioned blockchain-based network is associated with the fund, and the interoperability service translates the subscription order for the secondary permissioned blockchain-based network; receiving, by the orchestrator smart contract, a settlement confirmation for the subscription order from the secondary permissioned blockchain-based network via the interoperability service, wherein the interoperability service translates the settlement confirmation for the primary permissioned blockchain-based network; recording, by the orchestrator smart contract, asset positions in the investor portfolio based on the settlement confirmation; and transferring, by the investor portfolio smart contract, deposit tokens to a fund manager address for the fund on the primary permissioned blockchain-based network.

In one embodiment, each template portfolio model comprises a list of funds in the template portfolio model and a percentage of each fund in the template portfolio model.

In one embodiment, the tokenized cash balance comprises one or more tokens that represent a cash balance of the investor.

In one embodiment, the rebalancer module calculates the subscription order in response to the investor portfolio meeting a rebalancing criterion.

In one embodiment, the rebalancing criterion comprises an addition of cash into the investor portfolio.

In one embodiment, the rebalancing criterion comprises a change in template portfolio model.

In one embodiment, the subscription order is signed by a private key by a portfolio manager of the investor portfolio.

In one embodiment, the method may also include submitting, by the orchestrator smart contract, a cash transfer instruction for the subscription order to the deposit token smart contract, wherein the cash transfer instruction ringfences cash from the investor portfolio.

According to another embodiment, a non-transitory computer readable storage medium may include instructions stored thereon, which when read and executed by one or more computer processors, cause the one or more computer processors to perform steps comprising: receiving a plurality of template portfolio models for a plurality of investors; receiving a deployment of an investor portfolio smart contract for an investor portfolio for an investor; in response to the deployment, linking the investor portfolio smart contract to a selected template portfolio model; establishing a tokenized cash balance for the investor; receiving, by an investor portfolio smart contract, the tokenized cash balance; calculating a subscription order to align the investor portfolio to the selected template portfolio model, wherein the subscription order identifies a fund and an investment amount; routing the subscription order to a secondary permissioned blockchain-based network via an interoperability service, wherein the secondary permissioned blockchain-based network is associated with the fund, and the interoperability service translates the subscription order for the secondary permissioned blockchain-based network; receiving a settlement confirmation for the subscription order from the secondary permissioned blockchain-based network via the interoperability service, wherein the interoperability service translates the settlement confirmation for the primary permissioned blockchain-based network; recording asset positions in the investor portfolio based on the settlement confirmation; and transferring deposit tokens to a fund manager address for the fund on the primary permissioned blockchain-based network.

In one embodiment, each template portfolio model comprises a list of funds in the template portfolio model and a percentage of each fund in the template portfolio model.

In one embodiment, the tokenized cash balance comprises one or more tokens that represent a cash balance of the investor.

In one embodiment, the subscription order is calculated in response to the investor portfolio meeting a rebalancing criterion.

In one embodiment, the rebalancing criterion comprises an addition of cash into the investor portfolio.

In one embodiment, the rebalancing criterion comprises a change in template portfolio model.

In one embodiment, the subscription order is signed by a private key by a portfolio manager of the investor portfolio.

In one embodiment, the non-transitory computer readable storage medium may also include instructions stored thereon, which when read and executed by the one or more computer processors, cause the one or more computer processors to perform steps comprising: submitting a cash transfer instruction for the subscription order to the deposit token smart contract, wherein the cash transfer instruction ringfences cash from the investor portfolio.

According to another embodiment, a system may include: a primary permissioned blockchain-based network; a secondary permissioned blockchain-based network; and an interoperability service communicating with the primary permissioned blockchain-based network and the secondary permissioned blockchain-based network. A model registry smart contract on the primary permissioned blockchain-based network is configured to receive a plurality of template portfolio models for a plurality of investors, wherein each template portfolio model comprises a list of funds in the template portfolio model and a percentage of each fund in the template portfolio model; the primary permissioned blockchain-based network is configured to receive a deployment of an investor portfolio smart contract for an investor portfolio for an investor; the model registry smart contract is configured to deploy an investor portfolio smart contract for an investor portfolio to the primary permissioned blockchain-based network; in response to the deployment, the model registry smart contract is configured to link the investor portfolio smart contract to a selected template portfolio model; a deposit token smart contract on the primary permissioned blockchain-based network is configured to establish a tokenized cash balance for the investor; the investor portfolio smart contract is configured to receive the tokenized cash balance; a rebalancer module is configured to calculate a subscription order to align the investor portfolio to the selected template portfolio, wherein the subscription order identifies a fund and an investment amount; an orchestrator smart contract on the primary permissioned blockchain-based network is configured to route, the subscription order to the secondary permissioned blockchain-based network via the interoperability service, wherein the secondary permissioned blockchain-based network is associated with the fund; the interoperability service is configured to translate the subscription order for the secondary permissioned blockchain-based network; the interoperability service is configured to receive settlement confirmation for the subscription order from the secondary permissioned blockchain-based network and to translate the settlement confirmation for the primary permissioned blockchain-based network; the orchestrator smart contract is configured to receive the settlement confirmation for the subscription order from the interoperability service; the orchestrator smart contract is configured to route asset positions in the investor portfolio based on the settlement confirmation; and the investor portfolio smart contract is configured to deposit tokens to a fund manager address for the fund on the primary permissioned blockchain-based network.

In one embodiment, the rebalancer module is configured to calculate the subscription order in response to the investor portfolio meeting a rebalancing criterion.

In one embodiment, the rebalancing criterion comprises an addition of cash into the investor portfolio or a change in template portfolio model.

In one embodiment, the orchestrator smart contract is configured to submit a cash transfer instruction for the subscription order to the deposit token smart contract, wherein the cash transfer instruction ringfences cash from the investor portfolio.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for using cross-chain portfolio management platforms according to an embodiment;

FIG. 2 illustrates a method for using cross-chain portfolio management platforms according to an embodiment; and

FIG. 3 depicts an exemplary computing system for implementing aspects of the present disclosure.

### DETAILED DESCRIPTION OF PREFERRED EMBODIMENTS

Systems and methods for using cross-chain portfolio management platforms are disclosed.

Embodiments may provide a technology-based approach that enables a wealth manager to easily construct, deploy and manage model portfolios across multiple public and private assets, allowing a seamless investor experience with improved transparency.

Embodiments may enable the seamless deployment and automatic rebalancing of a large number of portfolios.

Embodiments may leverage smart contracts to represent and record the ownership of assets which could collapse the PM and operations roles into a single automated process, enabling portfolios to be deployed and rebalanced programmatically at scale. The presence of cash and fund ownership records on a shared ledger, combined with smart contract-enabled trade execution, may limit the need for costly reconciliations and occurrence of trade errors.

From an investor perspective, eliminating these friction points may enable PMs to be fully invested more consistently, meaning their portfolios would experience less cash drag.

Leveraging interoperability solutions to connect distinct blockchain networks may provide access to tokenized investments across disparate chains, allowing PMs to build holistic solutions with the inclusion of these investment opportunities, which otherwise might not be accessible.

Embodiments may enable a portfolio manager to seamlessly manage a large number of discretionary portfolios that are invested in a multitude of traditional and alternative investments that have been tokenized across various blockchains, all whilst preserving unique investor-level account customizations.

Embodiments may use a general-purpose tokenization platform as a base. Any suitable tokenization platform may be used as is necessary and/or desired.

Embodiments may work with various permissioned networks, such as permissioned blockchain-based networks. A standardized token may be used to represent funds on each network and enabled consistent interaction across each.

Embodiments may use interoperability services to provide connectivity between the networks.

Account abstraction infrastructure and contracts may be used to enable “gasless” interactions for the fund manager operating on certain networks.

Embodiments may provide cross-chain interoperability. Cross-chain interoperability, may be required to transmit messages containing financial transactions across networks in a secure manner. In embodiments, a token standard (e.g., asset token contracts that may extend the ERC-20 standard may promote the portability of assets across a single blockchain network, and may introduce control requirements necessary for financial products). Account abstraction, a means of simplifying the user experience for users interacting with blockchain networks, specifically the process of covering gas fees and implementing programmability, may also be used.

For Layer 1 blockchains, cross-chain interoperability may be achieved via asset transformation and cross-chain messaging. With asset transformation, also known as asset bridging, the asset moves from one blockchain to another. Two methods for achieving this are as follows: (1) wrapped assets—assets are locked on the source chain and either minted (created) as wrapped assets or unlocked on the destination chain; and (2) native assets—assets are burned on the source chain and minted (created) as native, non-wrapped assets on the destination chain.

For cross-chain messaging, the assets remain on the source chain and messages are sent between the source and a destination chain. Messages may include data containing instructions for execution on destination chains, confirmation of transfers or business data.

Cross-chain messaging has a number of advantages over asset transformation, such as there being a single source of truth (e.g., asset transformation could create ambiguity about the definitive source of truth for a given bridged asset.

In addition, investors may view an asset which exists on one chain differently from its wrapped equivalent on a different blockchain. Cross-chain messaging, in contrast, ensures assets remain on their source chain, avoiding duplication of assets across ledgers); flexibility (e.g., cross-chain messaging enables user-defined messages to be sent between chains, potentially providing utility beyond instructing movement of assets. For example, messages may be sent to confirm asset movement on a destination chain, to transmit business data maintained on a different blockchain (for example a client's Know Your Customer (KYC) status) or to leverage the benefits of account abstraction).

Cross-chain messaging may also increase security by reducing the risk of asset theft. For example, there are many examples in public blockchain ecosystems where the asset transformation approach has enabled malicious actors to gain access to private keys and steal user's tokens. A successful malicious event with cross-chain messaging, may have a lower impact since an attacker's actions could be restricted to simply sending invalid messages or denying access to the service, as opposed to obtaining unauthorized access to user's assets.

Embodiments may be directed to linking a portfolio contract to a model portfolio.

The orchestrator smart contract may compile orders and route them to the right permissioned blockchain-based network.

Embodiments may provide reserve balances for cash when buying/selling, by, for example, locking cash within a portfolio to facilitate settlement. For example, as part of the settlement process, on-chain cash may be transferred from an investor to a fund manager (and vice-versa) on a permissioned blockchain-based network. After the cash is minted on-chain, the Investor deposits on-chain cash into their specific investor portfolio smart contract that is linked to the chosen model.

When deposited, the amount of on-chain cash may be listed as a “depositBalance” within the investor portfolio smart contract. Once cash is deposited, the rebalancer module may produce orders that indicate the issuance and/or redemption of funds, and the amount of on-chain cash to be transferred.

When the orders are sent to the investor portfolio smart contract, the amount of on-chain cash from the first order may be moved from the “depositBalance” to a “reserveBuyBalance.” This balance is essentially reserved/frozen where neither the investor nor the fund manager can access the on-chain cash.

Once the investor's portfolio smart contract receives confirmation that the mint of the fund has been successful, the on-chain cash may be transferred to the respective fund manager, thereby making the “reserveBuyBalance” go to 0. This same process occurs for each order. For a Sell order, the “reserveSellBalance” may be used within the investor's portfolio smart contract instead.

Embodiments may track cross-chain positions to inform a holistic portfolio review.

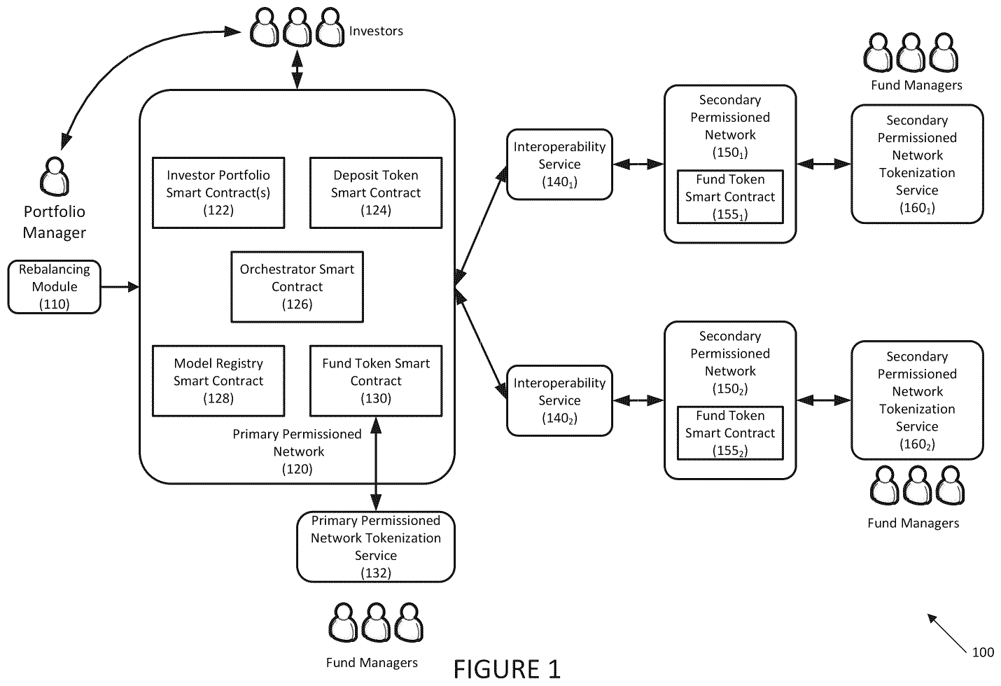

Referring to FIG. 1, a system for using cross-chain portfolio management platforms is disclosed according to an embodiment. System 100 may include primary permissioned network 120. Primary permissioned network, which may be a permissioned blockchain-based network, may include investor portfolio smart contract(s) 122 that may record an investor's cash and asset positions across multiple fund investments within a specific portfolio, while linking to a target model portfolio; model registry smart contract 128 that may track the inventory of all model portfolios and enables on-chain, transparent linkages between the models and the portfolios that subscribe to them; fund token contract 130 that may leverage a standard asset token contract, such as the Onyx Digital Assets Fungible Asset Contract (examples of asset token contracts are disclosed in U.S. patent application Ser. No. 18/410,732, the disclosure of which is hereby incorporated, by reference, in its entirety); deposit token smart contract 124 that may issue fiat currency deposit liabilities and provide the book of record (ledger), execute deposit issuance, redemptions and transactions, and access controls; and orchestrator smart contract 126 that may receive orders from rebalancing module 110, may route orders to secondary permissioned networks 150 for execution, and may coordinate settlement by linking cash and asset legs. Secondary permissioned networks 150 may be secondary permissioned blockchain-based networks.

Rebalancing module 110 that may be an on-chain or off-chain service that computes trade orders to align the investor's portfolio to target model allocations.

Primary permissioned network 120 may be provided with primary permissioned network tokenization service 132. Primary permissioned network tokenization service 132 may be an off-chain service that may generate tokens for funds.

Secondary permissioned network tokenization services 160 may provide similar functionality for secondary permissioned networks 150.

Interoperability services 140 may provide an interface between primary permissioned network 120 and secondary permissioned networks 150. Each interoperability service 140 may act as a “messaging channel” such that the source chain (i.e., the permissioned network sending the action) can message an action through the interoperability protocol to the destination chain (i.e., the recipient of the action), such as an action to buy or sell a particular fund. Interoperability services 140 may also be used in reverse to return a message from the destination chain to the source chain, such as a confirmation of the receipt and/or execution of action.

Secondary permissioned networks 150 may be networks that separate from primary permissioned network 120. Each secondary permissioned network 150 may be associated with a specific asset (e.g., funds) and may be provided with fund token smart contract 155 for that fund.

Fund managers and investors may interface with their respective networks using a User Interface or data connection (API, file upload, etc.).

In general, fund managers own the fund that is to be issued on the respective chains and may tokenize those funds through a respective tokenization service 160. Fund managers may also have a “cash account” on their source chains (e.g., on their secondary permissioned networks 150) such that even if a fund is issued on a different chain, the fund managers will still receive the cash from the buyer into their cash account or wallet.

Investors may interface with primary permissioned network 120 via a portfolio manager. The portfolio manager may set up investor portfolio smart contract 122 for each investor, as well as an on-chain cash account or wallet. The on-chain cash account or wallet may be used to enable the investor to “mint” on chain cash, and/or to receive on chain cash.

The portfolio manager may leverage rebalancing module 110 and may issue and manage investor portfolio smart contract 122 for one or more investors.

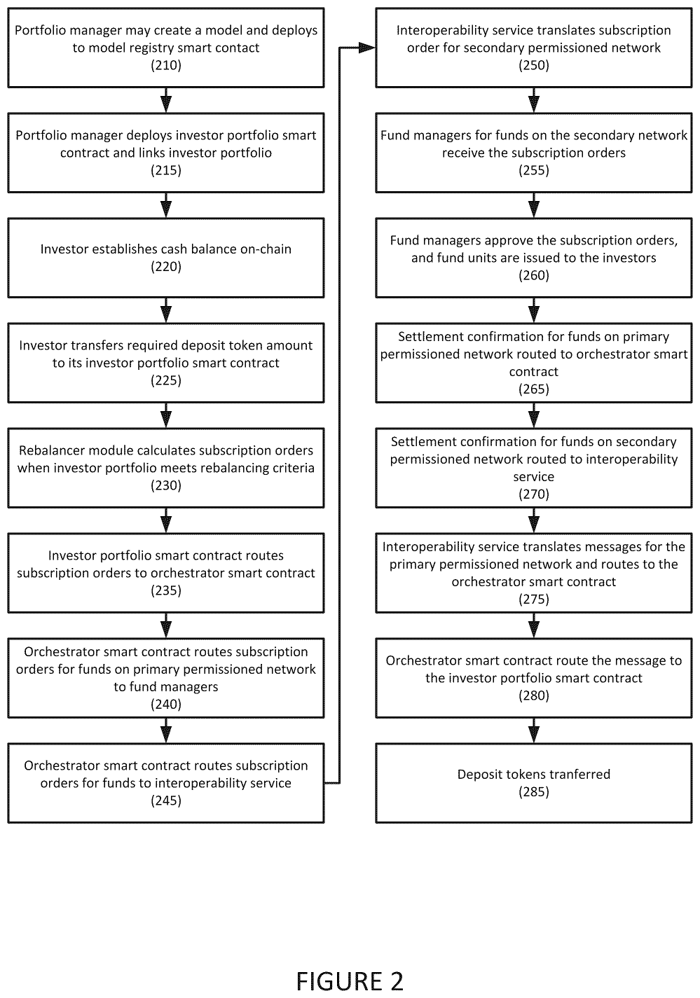

Referring to FIG. 2, a method for using cross-chain portfolio management platforms is disclosed according to an embodiment.

In step 210, a portfolio manager may create a model, such as a template portfolio model, for one or more investors that have similar risk/return objectives, and may deploy the template portfolio models to a model registry smart contract on a primary permissioned network, such as a primary blockchain-based network. The model registry smart contract may be a smart contract (i.e., self-executing code) that tracks the inventory of all model portfolios and enables on-chain, transparent linkages between the models and the portfolios that subscribe to them.

Each template portfolio model may include a list of funds that make up the template portfolio model and a percentage of each fund.

For example, during fund setup, fund managers may provide investment strategies for clients. The fund managers may provide investment vehicles, representing alternative investment, fixed income, and equity strategies, etc. for tokenization onto their chosen blockchain.

The fund manager may perform the functions of both a tokenization agent and a token administrator. This allows the fund manager to retain control of all relevant functionality—primarily minting and burning fund units—throughout the workflow. Other entities, such as transfer agents or other entities designated by the fund manager, may perform these functions.

During model and portfolio creation, the portfolio manager may create a series of investment models and may set up discretionary portfolios to follow these models for a number of investors. For example, an entry may be created for each investment model in the on-chain model registry smart contract that includes model metadata and portfolio manager details. The portfolio manager may then select specific funds and set percentage allocations to each—they may constitute the model portfolio's strategy. Allocation details may not be stored on-chain.

In step 215, the portfolio manager may deploy an investor portfolio smart contract for an investor portfolio to the primary permissioned network. The investor portfolio smart contract may record an investor's cash and asset positions across multiple fund investments within a specific portfolio and may be linked to the model registry smart contract on chain as well as to the relevant off-chain portfolio information.

The deployment of the investor portfolio smart contract may cause the investor portfolio smart contract to be linked to one of the template portfolio models. The investor may select the template portfolio model to link the investor portfolio to.

In step 220, the investor may establish a cash balance on-chain through a deposit token smart contract. For example, the investor may use a tokenization service to tokenize the cash balance, resulting in one or more tokens that represent the cash balance.

For example, the investor may need to establish a balance of cash on-chain to conduct the initial investment. The investor may request this balance, and upon acceptance, deposit tokens may be issued to the investor's blockchain address. This action enables the transfer of cash from off-chain to on-chain.

The investor may then deposit the on-chain cash to the portfolio, signaling it is ready for investment. This may emit a deposit event onto the blockchain in the process.

In step 225, the investor may transfer the required deposit token amount to its investor portfolio smart contract, preparing for investment.

In step 230, the investor's portfolio may meet a rebalancing criterion, such as being 100% invested in cash, a cash addition, a model change, etc. The rebalancing criteria may be any suitable criterion. In one embodiment, a rebalancer module may calculate any subscription orders required to align the investor's portfolio with the model and may be routed to the investor's portfolio smart contract.

For example, the deposit event may trigger the rebalancing module for the initial deployment of cash. The rebalancing module may calculate required trades by first comparing the existing composition of the portfolio—which for the initial deposit may be 100% cash versus the target portfolio allocations—and may then determine the quantities of fractional fund shares to be purchased. To make this calculation, the rebalancing module may retrieve the latest net asset value information from an off-chain reference data service, or it may use an oracle.

The rebalancer module may be an on-chain module or an off-chain module.

In step 235, the investor portfolio smart contract may send the subscription orders to the orchestrator smart contract. The orchestrator smart contract may compile the subscription orders and route them to the right secondary permissioned network, such as a secondary permissioned blockchain-based network. It may further coordinate settlement by linking cash and asset legs.

The subscription orders may be automatically augmented with blockchain data, simultaneously submitted onto the primary permissioned network and passed to the orchestrator smart contract for distribution. The blockchain transactions containing the orders may be signed by the portfolio manager's private key, given their discretion and control over investments in the portfolio. Each order may contain information about the asset, settlement location, amount, trade direction (buy/sell) and other necessary details.

The orchestrator smart contract may route and process each order sequentially and synchronously (i.e., Order #1 will need to have confirmed settlement before Order #2 can be distributed and settled, and so on, until all orders for a given portfolio are completed). In another embodiment, an asynchronous design for order submission and execution may be used.

For each order, the orchestrator smart contract may submit cash transfer instructions to the deposit token contract. These instructions result in the movement of cash from the investor's portfolio to an account in preparation for settlement. While in this account, the funds are ringfenced, as neither the portfolio manager nor the investor can access or move the funds, guaranteeing the settlement of the cash leg.

In step 240, for funds on the primary permissioned network, the orchestrator smart contract may route the subscription orders to fund managers on the primary permissioned network, and the fund managers may see that cash had been positioned for settlement on the primary permissioned network.

The subscription order may propagate to the fund manager effectively requesting the fund manager to “mint” or issue fund units to the portfolio. The request may be considered an on-chain recordation of the portfolio manager's order that would then automatically reconcile against the settlement when the fund manager later accepts the request.

For example, the fund manager may receive the request to “mint” fund units to the portfolio. For assets held directly on the primary permissioned network, fund units may be minted to (or burned from) the Portfolio Smart Contract of the investor.

In step 245, for funds on secondary permissioned networks, the orchestrator smart contract may queue the subscription orders and route the subscription orders to an interoperability service 140 may provide an interface between primary permissioned network for the appropriate secondary permissioned network.

In step 250, the interoperability service may translate the subscription order for the secondary permissioned network and may route the translated subscription order to the secondary permissioned network.

In step 255, the fund managers for funds on the secondary permissioned network may receive the subscription orders and may see that cash had been positioned for settlement on the primary permissioned network. The fund managers may access the information using a user interface, a data feed, etc.

The fund manager may receive the request to “mint” fund units to the portfolio. Fund units may be minted to (or burned from) blockchain addresses on each permissioned network that are unique to each portfolio. The portfolio manager may hold the private keys corresponding to these addresses.

In one embodiment, the fund manager may directly accept the request—signing and executing the acceptance transaction with a private key that corresponded to their externally owned account on-chain.

In another embodiment, an on-chain and off-chain infrastructure (e.g., an on-chain and off-chain ERC-4337 infrastructure) may be leveraged to implement account abstraction and to abstract away the gas fees that the fund manager may typically incur on a permissioned network subnet. For example, instead of an externally owned account, a smart contract wallet may be used for the fund manager. When the fund manager accepts the request, services may leverage a software development kit to create a user operation. This may include the fund manager's transaction intent (e.g., to accept or reject the request) that may be signed by both the fund manager for authentication and verification and the off-chain payment service, for validation of sponsorship.

The on-chain and off-chain infrastructure's bundler service may submit the signed user operation as a transaction onto the permissioned network, making the gas payment, and the transaction may be validated by the on-chain contracts and propagated onwards to the fund token contract. The payment service's on-chain contract may refund the gas fee to the bundler.

The fund manager's acceptance of the request may result in the issuance of fund units to the portfolio. This may constitute both order execution and settlement, compressed into one action, which reduces reconciliation requirements. For greater efficiencies, fund managers may automate the acceptance functionality provided an order meets a set of predetermined rules.

In step 260, the fund managers may approve the subscription orders, and fund units may be issued to the investors.

In step 265, for funds on the primary permissioned network, messages confirming settlement may be sent to the orchestrator smart contract on the primary permissioned network.

In step 270, for funds on the secondary permissioned networks, messages confirming settlement may be sent back to the primary permissioned networks through the interoperability service.

In step 275, the interoperability service may translate the messages for the primary permissioned network and may route the translated messages to the orchestrator smart contract on the primary permissioned network.

In step 280, the orchestrator smart contract may route the message to the investor portfolio smart contract where a record of the asset positions across multiple fund investments within a specific portfolio are held.

The orchestrator smart contract may finalize cash movements to the relevant fund manager's blockchain address, completing settlement.

In step 285, once the state of all orders in the investor portfolio smart contract are recorded as settled, deposit tokens may be transferred from the investor portfolio smart contract to the respective fund managers address on primary permissioned network.

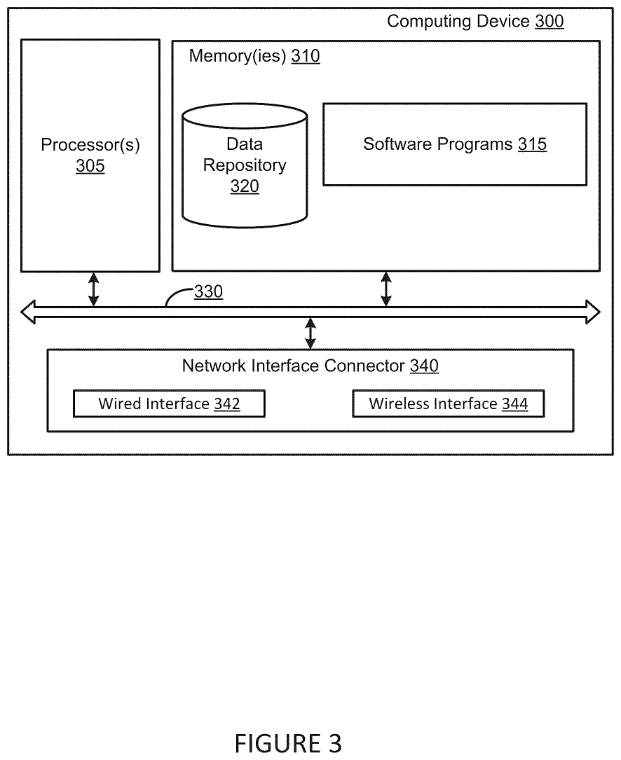

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, on a primary permissioned blockchain-based network and by a model registry smart contract, a plurality of template portfolio models for a plurality of investors;
receiving, by the primary permissioned blockchain-based network, a deployment of an investor portfolio smart contract for an investor portfolio for an investor;
in response to the deployment, linking, by the model registry smart contract, the investor portfolio smart contract to a selected template portfolio model;
establishing, by a deposit token smart contract, a tokenized cash balance for the investor;
receiving, by the investor portfolio smart contract, the tokenized cash balance;
calculating, by a rebalancer module, a subscription order to align the investor portfolio to the selected template portfolio model, wherein the subscription order identifies a fund and an investment amount;
sending, by the investor portfolio smart contract, the subscription order to an orchestrator smart contract;
routing, by the orchestrator smart contract, the subscription order to a secondary permissioned blockchain-based network via an interoperability service, wherein the secondary permissioned blockchain-based network is associated with the fund, and the interoperability service translates the subscription order for the secondary permissioned blockchain-based network;
receiving, by the orchestrator smart contract, a settlement confirmation for the subscription order from the secondary permissioned blockchain-based network via the interoperability service, wherein the interoperability service translates the settlement confirmation for the primary permissioned blockchain-based network;
recording, by the orchestrator smart contract, asset positions in the investor portfolio based on the settlement confirmation; and
transferring, by the investor portfolio smart contract, deposit tokens to a fund manager address for the fund on the primary permissioned blockchain-based network.

2. The method of claim 1, wherein each template portfolio model comprises a list of funds in the template portfolio model and a percentage of each fund in the template portfolio model.

3. The method of claim 1, wherein the tokenized cash balance comprises one or more tokens that represent a cash balance of the investor.

4. The method of claim 1, wherein the rebalancer module calculates the subscription order in response to the investor portfolio meeting a rebalancing criterion.

5. The method of claim 4, wherein the rebalancing criterion comprises an addition of cash into the investor portfolio.

6. The method of claim 4, wherein the rebalancing criterion comprises a change in template portfolio model.

7. The method of claim 1, wherein the subscription order is signed by a private key by a portfolio manager of the investor portfolio.

8. The method of claim 1, further comprising:
submitting, by the orchestrator smart contract, a cash transfer instruction for the subscription order to the deposit token smart contract, wherein the cash transfer instruction ringfences cash from the investor portfolio.

9. A non-transitory computer readable storage medium, including instructions stored thereon, which when read and executed by one or more computer processors in a permissioned blockchain-based network, cause the one or more computer processors to perform steps comprising:
receiving a plurality of template portfolio models for a plurality of investors;
receiving a deployment of an investor portfolio smart contract for an investor portfolio for an investor;
in response to the deployment, linking the investor portfolio smart contract to a selected template portfolio model;
establishing a tokenized cash balance for the investor;
receiving, by an investor portfolio smart contract, the tokenized cash balance;
calculating a subscription order to align the investor portfolio to the selected template portfolio model, wherein the subscription order identifies a fund and an investment amount;
routing the subscription order to a secondary permissioned blockchain-based network via an interoperability service, wherein the secondary permissioned blockchain-based network is associated with the fund, and the interoperability service translates the subscription order for the secondary permissioned blockchain-based network;
receiving a settlement confirmation for the subscription order from the secondary permissioned blockchain-based network via the interoperability service, wherein the interoperability service translates the settlement confirmation for the primary permissioned blockchain-based network;
recording asset positions in the investor portfolio based on the settlement confirmation; and
transferring deposit tokens to a fund manager address for the fund on the primary permissioned blockchain-based network.

10. The non-transitory computer readable storage medium of claim 9, wherein each template portfolio model comprises a list of funds in the template portfolio model and a percentage of each fund in the template portfolio model.

11. The non-transitory computer readable storage medium of claim 9, wherein the tokenized cash balance comprises one or more tokens that represent a cash balance of the investor.

12. The non-transitory computer readable storage medium of claim 9, wherein the subscription order is calculated in response to the investor portfolio meeting a rebalancing criterion.

13. The non-transitory computer readable storage medium of claim 12, wherein the rebalancing criterion comprises an addition of cash into the investor portfolio.

14. The non-transitory computer readable storage medium of claim 12, wherein the rebalancing criterion comprises a change in template portfolio model.

15. The non-transitory computer readable storage medium of claim 9, wherein the subscription order is signed by a private key by a portfolio manager of the investor portfolio.

16. The non-transitory computer readable storage medium of claim 9, further including instructions stored thereon, which when read and executed by the one or more computer processors, cause the one or more computer processors to perform steps comprising:
submitting a cash transfer instruction for the subscription order to the deposit token smart contract, wherein the cash transfer instruction ringfences cash from the investor portfolio.

17. A system, comprising:
a primary permissioned blockchain-based network;
a secondary permissioned blockchain-based network; and
an interoperability service communicating with the primary permissioned blockchain-based network and the secondary permissioned blockchain-based network;
wherein:
a model registry smart contract on the primary permissioned blockchain-based network is configured to receive a plurality of template portfolio models for a plurality of investors, wherein each template portfolio model comprises a list of funds in the template portfolio model and a percentage of each fund in the template portfolio model;
primary permissioned blockchain-based network is configured to receive a deployment of an investor portfolio smart contract for an investor portfolio for an investor;
in response to the deployment, the model registry smart contract is configured to link the investor portfolio smart contract to a selected template portfolio model;
a deposit token smart contract on the primary permissioned blockchain-based network is configured to establish a tokenized cash balance for the investor;
the investor portfolio smart contract is configured to receive the tokenized cash balance;
a rebalancer module is configured to calculate a subscription order to align the investor portfolio to the selected template portfolio, wherein the subscription order identifies a fund and an investment amount;
an orchestrator smart contract on the primary permissioned blockchain-based network is configured to route, the subscription order to the secondary permissioned blockchain-based network via the interoperability service, wherein the secondary permissioned blockchain-based network is associated with the fund;
the interoperability service is configured to translate the subscription order for the secondary permissioned blockchain-based network;
the interoperability service is configured to receive settlement confirmation for the subscription order from the secondary permissioned blockchain-based network and to translate the settlement confirmation for the primary permissioned blockchain-based network;
the orchestrator smart contract is configured to receive the settlement confirmation for the subscription order from the interoperability service;
the orchestrator smart contract is configured to route asset positions in the investor portfolio based on the settlement confirmation; and
the investor portfolio smart contract is configured to deposit tokens to a fund manager address for the fund on the primary permissioned blockchain-based network.

18. The system of claim 17, wherein the rebalancer module is configured to calculate the subscription order in response to the investor portfolio meeting a rebalancing criterion.

19. The system of claim 18, wherein the rebalancing criterion comprises an addition of cash into the investor portfolio or a change in template portfolio model.

20. The system of claim 17, wherein the orchestrator smart contract is configured to submit a cash transfer instruction for the subscription order to the deposit token smart contract, wherein the cash transfer instruction ringfences cash from the investor portfolio.
